(19) United States
(12) Patent Application Publication
(10) Pub. No.: US 2019/0185956 A1
(43) Pub. Date: Jun. 20, 2019

(54) CHARGING APPARATUS FOR THE DIMENSIONALLY STABLE HEAT TREATMENT OF WORKPIECES

(71) Applicant: Härterei Reese Bochum GmbH, Bochum (DE)

(72) Inventors: Gerhard Reese, Bochum (DE); Thorsten Stadtler, Bochum (DE)

(73) Assignee: Härterei Reese Bochum GmbH, Bochum (DE)

(21) Appl. No.: 16/322,061

(22) PCT Filed: Aug. 10, 2016
(86) PCT No.: PCT/EP2016/069052

§ 371 Date: Jan. 30, 2019

(51) Int. Cl. C21D 9/00; F27D 5/00; C21D 9/32; C21D 9/40

(52) U.S. Cl. CPC C21D 9/0018; F27D 5/0006; C21D 9/40; C21D 9/32; F27D 5/0025

(57) ABSTRACT

The invention relates to a charging apparatus for the dimensionally stable heat treatment of workpieces (1), in particular those of a disk or ring shape, having a charging rack (10) for horizontally mounting the workpiece (1), wherein at least s three screw-type mandrels or ball joint mandrels (2) are arranged on the charging rack (10), the ball joint mandrels (2) having a base plate (3) with a female thread (7), a screw element (4) with a male thread (7) matched to the female thread (7) and a head that has a spherical segment surface, as well as a pressure piece (5) matched precisely to the spherical segment surface of the head and arranged movably thereon.

The invention relates to a charging apparatus for the dimensionally stable heat treatment of workpieces which in particular have a disk or ring shape, with a charging rack for the horizontal support of the workpiece as well as to a method for the dimensionally stable hardening of workpieces and the use of ball joint mandrels employed in the heat treatment of workpieces.

The heat treatment of workpieces made of steel (inter alia gearwheels) is aimed at improving the wear resistance and strength characteristics of the treated components. For this purpose, the workpieces are heated in furnaces to temperatures ranging between 700° C. and 1000° C. and when in austenitized state subjected to a quick quenching process. Quenching is usually effected using, for example, oil is or polymer solutions as liquid quenching media.

During the process of subjecting the austenitized gearwheels to quenching in a liquid medium, said medium starts boiling at the hot workpiece surfaces causing a vapor layer to build up. This vapor layer, which is also known as vapor phase, greatly influences the cool-down rate of the workpiece. For that reason, emphasis has been on keeping the vapor phase to a minimum with a view to achieving a more uniform workpiece cooling. To some extent, this is accomplished by consistently recirculating the quenching medium and/or moving the workpieces within the quenching medium. After quenching, the workpieces are heated to temperatures within so-called tempering stages with a view to achieving the required strength resp. hardness characteristics. Gearwheels having hub diameters in excess of about 25% of the outer diameter are as a rule positioned horizontally on charging racks and in this way subjected to the above described heat treatment process. However, horizontal charging leads to axial runout errors (wobble) and causes conically deformed gearteeth. These deformation characteristics are on the one hand due to the different quenching rates arising between the upper and lower planar surfaces of the gearwheel during the quenching process and on the other hand on the localized (punctual) support of the gearwheel on the charging rack. While the upper planar surface of the gearwheel can expand unhindered under the influence of heat, the lower planar surface of the gearwheel is prevented from expanding due to the localized (punctual) contact on the charging rack.

As a result of the difference in growth arising between the upper and lower planar surface during heat treatment a conical deformation in the shape of the gearteeth is caused. Taper of the gearteeth makes it necessary to carry out intensive grinding rework during final machining of the gearteeth that follows heat treatment. In unfavorable cases, the depth of hardness achieved through the heat treatment performed is machined down and thus diminishes to a great extent as a result of the mechanical rework necessitated by the deformation. In the worst case, deformation is so pronounced that even by mechanical reworking the gearwheel cannot be rendered useful for the intended purpose. Such gearwheels are to be considered rejects and must be scrapped.

The objective of the invention is thus to avoid the disadvantages during heat treatment described hereinbefore without any appreciable increase in the effort required for the treatment.

This objective is accomplished by providing a charging apparatus of the kind first mentioned above, in which at least three screw-type mandrels or ball joint mandrels are arranged on the charging rack, wherein said ball joint mandrels have a base plate provided with a female thread, a screw element with a male thread atched to the female thread and a head shaped in the form of a spherical segment as well as a pressure piece matched precisely to the spherical ball segment surface of the head on which it is movably arranged.

The invention also relates to a method for the heat treatment of workpieces by means of such a charging apparatus as well as the use of such ball joint mandrels in the heat treatment of workpieces on a charging rack.

The charging apparatus comprises a charging rack, which is preferably made of heat-resistant steel. In particular, a heat-resistant steel of grade 1.4849 can also be used for the screw-type mandrels or ball joint mandrels.

The charging rack of the charging apparatus proposed by the invention preferably has the shape of a star, in particular a spoke wheel with six to nine arms. In principle, however, any other form of rack may be provided, on condition that the rack is permeable to and allows the passage of hot air. This applies in particular to any form of grating.

The workpiece mounted on the charging rack has in particular a disk or ring shape. Preferably, said workpiece is a gearwheel of larger size or dimension, with diameters of considerably more than 1,000 mm being easily possible.

The workpiece is not mounted directly on the charging rack, but is supported on at least three screw-type mandrels, in particular ball joint mandrels, which are arranged on the charging rack. The ball joint mandrels consist of a base plate resting on the charging rack and a screw element threaded into a female thread of the base plate. The screw element can be adjusted in height via the screw thread. The screw element proper is provided with a head in the form of a spherical segment surface on which a complementary shaped pressure piece is arranged so as to be freely movable. The pressure piece can move freely on the surface of the spherical segment and thus also adapt to inclined surfaces.

If screw-type mandrels are used, they are screwed into the charging rack in a height-adjustable manner. Screw-type mandrels may as well be screwed into base plates which are mounted on the charging rack.

In particular, the ball joint mandrels allow an accurate horizontal alignment of a workpiece on a charging rack, which is distorted, for example, by long-term multiple use. At the same time, the ball joint mandrels also enable workpieces with an irregular surface to be treated, and in this way allow differences in height as well as inclinations to be compensated.

As a rule, the number of mandrels used corresponds at least to the number of arms of the charging rack or a multiple thereof.

The mandrels are preferably provided with a trapezoidal thread, which is best suited for the purposes of the invention. Trapezoidal threads generally have a large pitch with strong thread profiles, which is particularly advantageous for the transmission of axial forces.

The mandrels serve to absorb the dimensional changes of the workpiece during heat treatment as well as during quenching/cooling. During this process, relative movements are encountered on the one hand between the surface of the screw element and the underside of the pressure piece, and between the upper side of the pressure piece and the workpiece on the other. In order to keep friction low in this area, it is advisable to apply a high-temperature lubricant to the sliding surfaces, either in the area of the ball joint or in the area of the contact surface between the workpiece and the head of the screw or pressure piece. For example, a copper paste known per se can be used to serve as lubricant here. Other lubricants, such as graphite, may also be employed.

Moreover, making use of the inventive charging apparatus the invention further relates to a method involving the following steps:
Provision of a charging rack;
Arranging at least three screw-type mandrels, in particular ball joint mandrels, on the charging rack, wherein said ball joint mandrels have a base plate provided with a female thread, a screw element with a male thread matched to the female thread and a head shaped in the form of a spherical segment as well as a pressure piece matched precisely to the spherical ball segment surface of the head on which it is movably arranged;
Mounting the workpiece on the mandrels;
Alignment of the mandrels (2);
Applying heat to the workpiece (1) and, if considered necessary, applying shielding and process gas over a desired period of time;
Quenching/cooling the workpiece (1) in a customary cooling medium and
If required or expedient, tempering the workpiece (1).

According to the invention, this is a charging technique which enables the uniform thermal expansion of the lower planar face of horizontally charged gearwheels (or is other ring-shaped workpieces) to be achieved. For this purpose, the gearwheels are preferably placed on so-called ball joint mandrels. Such ball joint mandrels consist of three parts: A base plate with trapezoidal female thread is positioned on the charging rack. Following this, a screw with trapezoidal thread is screwed into the base plate. The head of the screw is shaped like an upper spherical segment. A precisely fitting pressure piece is positioned on the surface of this spherical segment, said pressure piece being movably supported on the spherical segment. Considering the geometry, weight and circumference of the gearwheel, several ball joint mandrels are now positioned under the gearwheel. The gearwheel is now placed onto the pressure pieces of the ball joint mandrels. Any difference in height existing due to the frequent use of the charging racks can be overcome by threading in or unscrewing the screw, so that all ball joint mandrels are now arranged “hand-tight” under the gearwheel.

In this position, the gearwheel is now charged to the furnace system. During the heating process, the gearwheel now undergoes thermal expansion as described above. As a result of the gearwheel being supported on ball joint mandrels, the expansion of the lower planar surface can now occur without major impairment. Due to structural modification caused by the heat treatment, the volume of the material increases, which manifests itself in the form of growth. Such growth must also be able to take place unhindered so that any undesirable change in shape, such as taper of the gearteeth, is kept to a minimum only. If the gearwheel is mounted on ball joint mandrels, this growth can also take place unhindered. As a result of using the ball joint mandrels, growth and thermal expansion of a horizontally charged gearwheel (or other ring-shaped workpieces) can take place unhindered to a large extent, so that undesirable, irregular deformation such as, for example, gearteeth taper can be significantly reduced.

The method proposed by the invention can be employed both for the quenching is and tempering of workpieces, for example at temperatures of 850° C., and for case hardening purposes at 930 to 980° C., generally under an inert gas shield and process gas. It is particularly suitable for disk-shaped and ring-shaped workpieces, primarily for gearwheels. The treatment times depend on the desired depth of hardening and the thickness of the material.

In conclusion, the invention also relates to the use of ball joint mandrels, as they have been described hereinbefore, for the dimensionally stable heat treatment of workpieces on a charging rack in horizontal charging position.

The invention is explained in more detail by way of the enclosed figures where

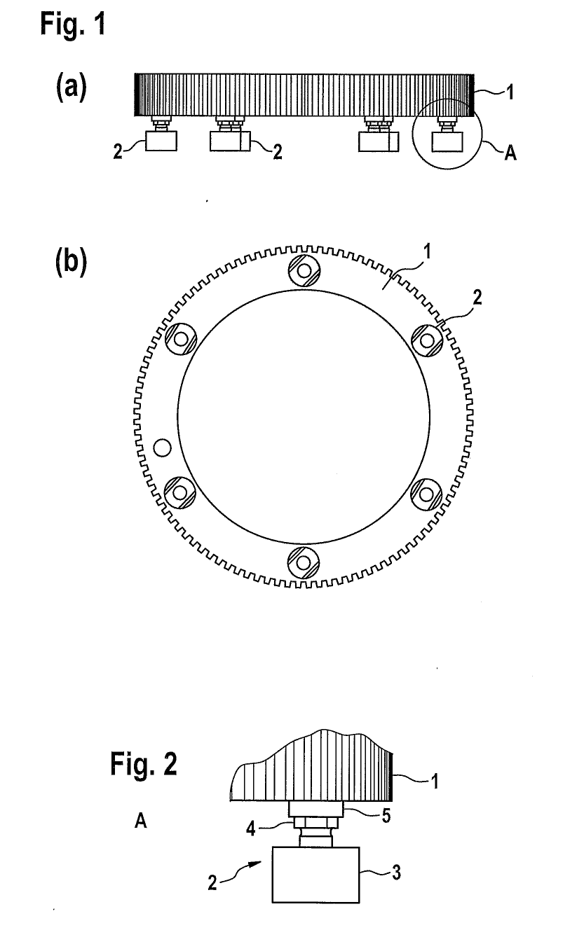

FIG. 1 shows a side view as well as a view from below of a gearwheel mounted on ball joint mandrels as provided by the invention;

FIG. 2 is an enlarged representation of section A shown in FIG. 1;

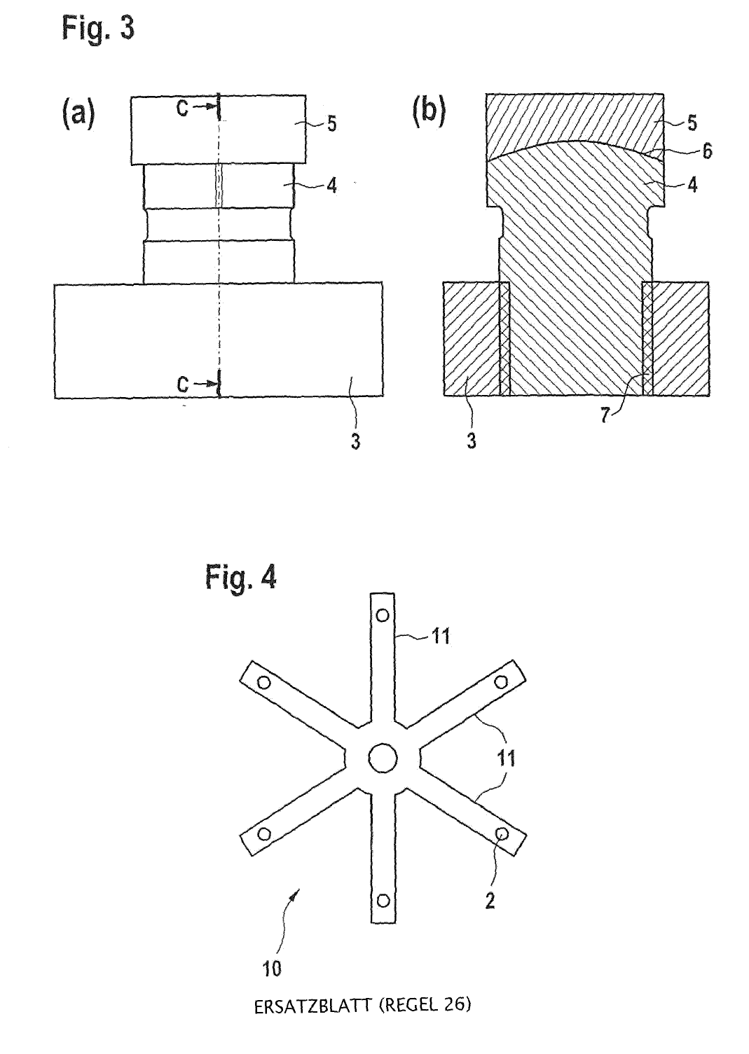

FIG. 3: illustrates a variant of a ball joint mandrel as a sectional view seen from the side; and

FIG. 4 is a representation of a star-shaped charging element, as it can be used as a charging rack according to the invention.

From FIG. 1a a gearwheel 1 with gearteeth shown on the outside can be seen mounted on 6 ball joint mandrels 2. FIG. 1b shows the same gearwheel seen from below with the ball joint mandrels 2 evenly distributed over the circumference, said mandrels supporting the gearwheel on a charging rack (not shown). The ball joint mandrels are neither permanently connected to the gearwheel nor to the charging rack.

In FIG. 2 section A from FIG. 1a is illustrated showing gearwheel 1 and the ball joint mandrel 2 said ball joint mandrel consisting of the base plate 3 accommodating the screw element 4. Via the head of the screw element 4 the pressure piece 5 is supported, on which the gearwheel 1 is mounted.

FIG. 3(a) is a side view of a ball joint mandrel 2 with the base plate 3, the screw element 4 and the pressure piece 5. FIG. 3(b) is a view of the ball joint mandrel along the section line C-C with the screw element 4 being threaded into the base plate 3. The screw element 4 is provided with a male thread that engages with a female thread 7 of the base plate 3. Preferably, the female thread is a trapezoidal thread.

Furthermore, screw element 4 has a hexagonal head which allows the use of a wrench. The top head surface 6 has the shape of a spherical segment, same as, complementary thereto, the lower surface of the pressure piece 5. The pressure piece 5 can thus move freely in all directions on the head of the screw element 4.

In particular, the pressure piece is thus able to compensate for oblique positions of the charging rack and/or balance out the surfaces of the workpiece that deviate from the horizontal.

As already mentioned, a lubricant can be applied to the spherical ball segment surface 6 as well as the surface of the pressure piece 5 with a view to minimizing friction between the screw element 4 and the pressure piece 5, and the pressure piece 5 and the workpiece 1, respectively.

FIG. 4 finally shows a charging rack 10 in the form of a star, which is suitable for the horizontal accommodation of a disk-shaped or ring-shaped workpiece. The screw mandrels or ball joint mandrels 2 are placed at regular intervals on the charging rack, preferably one mandrel in the area of each arm 11, whereupon the workpiece is then placed.

1. Charging apparatus for the dimensionally stable heat treatment of workpieces, in particular those of a disk or ring shape, having a charging rack (10) for horizontally mounting the workpiece (1), characterized in that at least three screw-type mandrels or ball joint mandrels (2) are arranged on the charging rack (10), wherein the ball joint mandrels having a base plate (3) with a female thread (7), a screw element (4) with a male thread (7) matched to the female thread (7) and a head that has a spherical segment surface, and a pressure piece (5) matched precisely to the spherical segment surface of the head and arranged movably thereon.

2. Charging apparatus according to claim 1, characterized in that the screw-type mandrels are threaded into the charging rack in a height-adjustable manner.

3. Charging apparatus according to claim 1, characterized in that charging rack (10) and ball joint mandrels (2) are manufactured from a heat-resistant steel.

4. Charging apparatus according to claim 1 comprising a charging rack (10) in the form of a grating or a star having several arms (11).

5. Charging apparatus according to claim 4, characterized in that the charging rack (10) has six to nine arms (11).

6. Charging rack according to claim 4 or 5, characterized in that the number of mandrels (2) corresponds at least to the number of spokes (11).

7. Charging rack according to claim 1, characterized in that the mandrels (2) have a trapezoidal thread (7).

8. Charging apparatus according to claim 1, characterized in that the ball joint mandrels (2) are provided with a lubricant, in particular a copper paste, between the head and the pressure piece (5) and/or on top of the pressure piece (5).

9. Charging apparatus according to claim 1 with workpiece (1), in particular a gearwheel, placed on it.

10. Method for the dimensionally stable heat treatment of workpieces having a disk or ring shape comprising the following steps:
Provision of a charging rack (10) in the form of a spoke wheel;
Arranging at least three screw-type mandrels or ball joint mandrels (2), on the charging rack, wherein said ball joint mandrels (2) have a base plate (3) provided with a female thread (7), a screw element (4) with a male thread (7) matched to the female thread (7) and a head shaped in the form of a spherical segment as well as a pressure piece (5) matched precisely to the spherical ball segment surface of the head on which it is movably arranged;
Mounting the workpiece (1) on the mandrels (2);
Alignment of the mandrels (2);
Applying heat to the workpiece (1) over a desired period of time;
Quenching/cooling the workpiece (1) in a customary cooling medium and
If required or expedient, tempering the workpiece (1).

11. Method according to claim 10, characterized in that a charging rack (10) is used that is provided with six to nine arms.

12. Charging rack according to claim 11, characterized in that the number of mandrels (2) corresponds at least to the number of spokes (11) of the charging rack (10).

13. Method according to claim 10, characterized in that the contact surfaces (6) of the pressure pieces (5) of the ball joint mandrels (2) are lubricated via the screw element (4) and/or the workpiece (1).

14. Use of ball joint mandrels in a charging apparatus for the dimensionally stable heat treatment of workpieces in horizontal position, wherein said ball joint mandrels (2) have a base plate (3) provided with a female thread (7), a screw element (4) with a male thread (7) matched to the female thread (7) and a head shaped in the form of a spherical segment as well as a pressure piece (5) matched precisely to the spherical segment surface of the head on which it is movably arranged.
